(19) United States
(12) Patent Application Publication
(10) Pub. No.: US 2013/0000039 A1
(43) Pub. Date: Jan. 3, 2013

(54) Exam Table Step Platform With Attached Handles

(76) Inventor: Constance Hardenburg, San Tan Valley, AZ (US)

(21) Appl. No.: 13/171,706

(22) Filed: Jun. 29, 2011

(51) Int. Cl. A61G 13/10

(52) U.S. Cl. 5/507.1

(57) ABSTRACT

A step platform with attached handles comprising a platform at a bottom portion, where the platform is placed on the ground next to a medical exam table, and where the platform includes a front wall, a back wall, a pair of lateral walls, and a top surface to create a generally rectangular shape; a set of lateral support members attached at each corner of the platform, where the set of lateral support members extend vertically from the platform and then extend out at an upper portion; an inner handle bar connecting the lateral support members at the upper portion, where the inner handle bar provides a first handle for a user to grasp when stepping onto the platform; and an outer handle bar connecting the lateral support members, where the outer handle bar provides a second handle for the user to grasp.

### BACKGROUND OF THE INVENTION

1. Field of the Invention

The present invention relates to a step to assist a user when maneuvering around an exam table where the step includes a set of lateral handles to ensure that the user does not slip or lose their footing when standing on the step.

2. Description of Related Art

Typical medical exam tables require individuals to step or climb onto a high foundation in order to position themselves onto the mattress. Because of the high placement of the table mattress persons with age, health or weight complications may find it difficult to lift themselves unassisted onto the table. Often repeated attempts are made to climb upon the table or, as an embarrassing last resort, the nurse or doctor must assist the patient by providing them with a boost.

Presently there are few accessories available to assist the patent when mounting the exam tables. As a necessary aid, some exam tables include handlebars which allow the user to pull themselves onto the table. For example, U.S. Pat. No. 5,678,267 by Florence E. Kinder discloses a medical examination table handle system wherein a rail is attached to the side of the table. The rail provides the user with an adjustable grip to pull themselves on the table. The rail is beneficial to those users who are strong enough to pull their body weight up but some users may still require additional assistance. In U.S. Pat. No. 6,550,084 by Paul J. Siepmann discloses a medical examination table step wherein a step is built into the base of an exam table and tucks away when not in use. The step provides the user with a greater height advantage to climb onto the table. While the step is advantageous to the user it may also be hazardous if no handles are included to ensure that the user does not lose their footing or balance.

Therefore, it would be desirable in the art to provide a non-slip step or platform for a user to more easily mount a medical exam table. It would also be beneficial in the art to include a handle with the step to ensure that the user does not lose their footing when stepping onto the platform.

### SUMMARY OF THE INVENTION

In view of the foregoing disadvantages inherent in the prior art, the general purpose of the present invention is to provide a step platform with attached handles, configured to include all of the advantages of the prior art, and to overcome the drawbacks inherent therein.

Accordingly, an object of the present invention is to provide a non-slip platform as an assisting device to allow a user to more easily step onto a medical exam table.

Another object of the present invention is to provide a handle attached to the platform to ensure that the user is balanced when stepping onto the table.

To achieve the above objects, in an aspect of the present invention, a step platform with attached handles is disclosed comprising a platform at a bottom portion, where the platform is placed on the ground next to a medical exam table, and where the platform includes a front wall, a back wall, a pair of lateral walls, and a top surface to create a generally rectangular shape; a set of lateral support members attached at each corner of the platform, where the set of lateral support members extend vertically from the platform and then extend out at an upper portion; an inner handle bar connecting the lateral support members at the upper portion, where the inner handle bar provides a first handle for a user to grasp when stepping onto the platform; and an outer handle bar connecting the lateral support members, where the outer handle bar provides a second handle for the user to grasp.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a step platform with attached handles in accordance with an exemplary embodiment of the present invention.

### DETAILED DESCRIPTION OF THE DRAWINGS

The present invention relates to a step to assist a user when mounting onto an exam table where the step includes a set of lateral handles to ensure that the user does not slip or lose their footing when standing on the step. The present invention provides a step platform with attached handles to assist patients who due to age, weight, physical disabilities or health complications may have difficulties getting onto the exam table. The step platform with attached handles may be made from a lightweight aluminum body for ease of mobility, while the top surface of the step and the handles are made from rubber to ensure that the user's hands and feet to not slip during use. When pressed flush against a standard medical exam table, the step platform with attached handles serves as a scaffolding base utilized by the patents as they proceed to step up and down from the exam table.

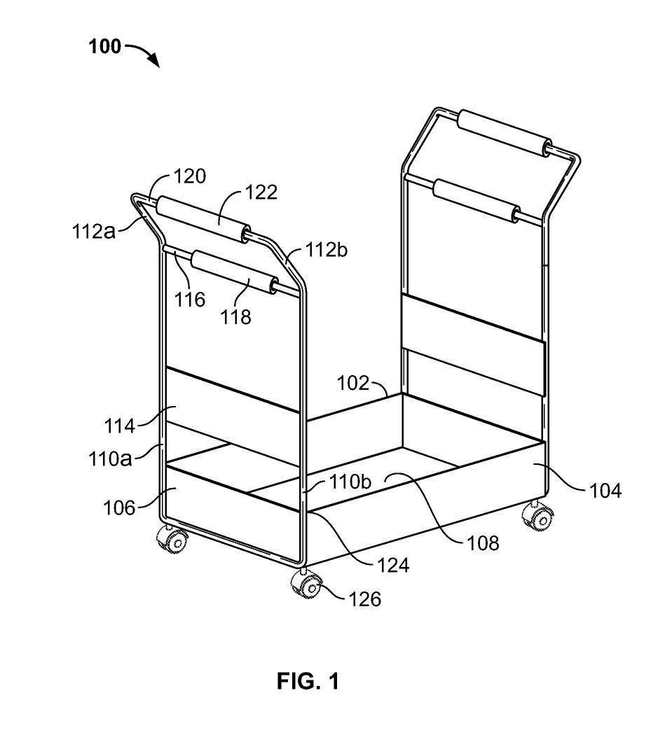

Tuning now descriptively to the drawings, referring to FIG. 1, a perspective view of a step platform with attached handles (100) is shown in accordance with an exemplary embodiment of the present invention. The step platform with attached handles (100) includes a platform (102) at a bottom portion where the platform (102) is in contact with the ground next to a medical exam table. The platform (102) comprises a front wall (104), a back wall (not shown), a pair of lateral walls (106) (hereinafter lateral walls) and a top surface (108). The walls (104, 106) provide the height for the platform (102) and in turn the height for the step of the step platform with attached handles (100).

The platform (102) may have a generally rectangular shape (as shown) wherein the front wall (104) and the back wall are longer than the lateral walls (106). Alternatively, the platform (102) may be square wherein the front wall (104) and the back wall are the same length as the lateral walls (106). The platform (102) may be made from a plastic, aluminum, wood or another light building material. The top surface (108) may be covered with a non-slip material like a textured, rubber mat to ensure that a user does not slip or lose their footing when standing on the platform (102).

Rising vertically form the platform (102) may be a set of lateral support members (110a, 110b) (hereinafter lateral support members). The lateral support members (110a, 110b) are attached at each corner of the platform (102). The lateral support members (110a, 110b) may be made from a lightweight metal or a plastic material for durable strength and easy maneuverability of the step platform with attached handles (100). Along a mid portion of the lateral support members (110a, 110b) may be a lateral support beam (114). The lateral support beam (114) connects the lateral support members (110a, 110b) to provide strength and support for the step platform with attached handles (100) during use.

At an upper portion (112a, 112b) of the lateral support members (110a, 110b) may be two adjacent sets of handle bars, a pair of inner handle bars (116) (hereinafter inner handle bar) and a pair of outer handle bars (120) (hereinafter outer handle bars), which connect the lateral support members (110a, 110b) together. The inner handle bar (116) may be positioned directly above the lateral wall (106) whereas the outer handle bar (120) may be positioned a few inches or up to a foot outside the inner handle bar (116). The inner handle bar (116) may provide a first handle or grip for a user to grasp when stepping onto the platform (102) and the outer handle bar (120) may provide an alternative or second handle for the user to grasp when stepping onto the platform (102).

The upper portion (112a, 112b) of the lateral support members (110a, 110b) may be straight or curved. If the upper portion (112a, 112b) is straight, the outer handle bar (120) extends directly from the inner handle bar (116) on the horizontal plane. If the upper portion (112a, 112b) is curved (as shown), the inner handle bar (116) and the outer handle bar (120) are fastened to the lateral support members (110a, 110b) on an outward sloping curve. The inner handle bar (116) and the outer handle bar (120) may be made from the same material as the lateral support members (110a, 110b) so that they do not bend or snap when a user rests their weight upon the handle bars (116, 120).

The inner handle bar (116) and the outer handle bar (120) may include an inner handle cover (118) and an outer handle cover (122) respectively. The inner handle cover (118) and the outer handle cover (122) are made from a material strong enough not to warp under the weight of the user when grasping the handle covers (118, 122) while still comfortable grip against the user's hands. The inner handle cover (118) and the outer handle cover (122) may be made from wood, rubber, plastic, neoprene, gel-filled plastic or another comfortable gripping material.

The lateral support members (110a, 110b) may be telescoping to allow the user to adjust the height of the inner handle bar (116) and the outer handle bar (120). Also, a hinge (124) may be attached to the lateral support members (110a, 110b) at a point where the lateral support members (110a, 110b) meet the platform (102). The hinge (124) enables the lateral support members (110a, 110b) to pivot and fold against the top surface (108) of the platform (102). By folding or collapsing the lateral support members (110a, 110b) the step platform with attached handles (100) is more easily stored because of its compact size.

Additionally, the platform (102) may include a set of locking wheels (126) to allow the user to move the step platform with attached handles (100) to a desired location during use. Alternatively, the platform (102) may include a set of rubber feet to lift the platform (102) slightly from the ground thereby preventing scratches on the floor when the step platform with attached handles (100) is moved.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A step platform with attached handles comprising:
a platform at a bottom portion, where said platform is placed on the ground next to a medical exam table, and where said platform includes a front wall, a back wall, a pair of lateral walls, and a top surface to create a generally rectangular shape;
a set of lateral support members attached at each corner of said platform, where said set of lateral support members extend vertically from said platform and then extend out at an upper portion;
a pair of inner handle bars connecting said lateral support members at said upper portion, where said inner handle bars provides a first handle for a user to grasp when stepping onto said platform; and
a pair of outer handle bars connecting said lateral support members, where said pair of outer handle bars provides a second handle for said user to grasp.

2. The step platform with attached handles according to claim 1, wherein said upper portion of said lateral support members is curved.

3. The step platform with attached handles according to claim 1, wherein said inner handle bar and said outer handle bar includes a handle cover to provide a more comfortable grip for said user.

4. The step platform with attached handles according to claim 3, wherein said handle cover is made from one of at least wood, plastic, neoprene, rubber and a gel-filled plastic.

5. The step platform with attached handles according to claim 1, wherein said lateral support members are telescoping to adjust the height of said inner handle bar and said outer handle bar.

6. The step platform with attached handles according to claim 1, wherein said top surface includes a non-slip covering to prevent said user from slipping when stepping onto said platform.

7. The step platform with attached handles according to claim 1, wherein said lateral support member includes a set of hinges at a portion where said lateral support members meets said platform, where said hinge allows said lateral support member to fold against said top surface of said platform.

8. The step platform with attached handles according to claim 1, wherein said lateral support members includes a lateral support beam that extends between said lateral support members.

9. The step platform with attached handles according to claim 1, wherein said platform includes a set of wheels to enable said user to move said step platform with attached handles to a desired location during use.

10. The step platform with attached handles according to claim 1, wherein said platform includes a set of rubber feet to lift the platform above the ground during use.

11. The step platform with attached handles according to claim 1, wherein said inner handle bar is positioned directly above said lateral walls of said platform.

12. The step platform with attached handles according to claim 1, wherein said platform, said lateral support members, said inner handle bar and said outer handle bar are made from a lightweight aluminum material.
